(19) United States
(12) Patent Application Publication
(10) Pub. No.: US 2005/0248496 A1
(43) Pub. Date: Nov. 10, 2005

(54) ADJUSTABLE ANTENNA MOUNT FOR A MOBILE PHONE CELL STATION

(76) Inventors: Michael Chen, Shihzhi City (TW); Dixie Tsao, Shihzhi City (TW); Mike Chang, Shihzhi City (TW)

Correspondence Address: Dennison, Schultz & Dougherty & MacDonald, Suite 105, 1727 King Street, Alexandria, VA, 22314, US

(21) Appl. No.: 10/841,450

(22) Filed: May 10, 2004

(51) Int. Cl. H01Q 3/00; H01Q 3/02

(52) U.S. Cl. 343/766; 343/882

(57) ABSTRACT

An antenna mount for a mobile phone cell station has a stationary base and a rotating base with an antenna. The rotating base is mounted rotatably on the stationary base. The stationary base has a motor and a horizontal gear set, and the rotating base has a motor and a vertical gear set. The motors are operated and controlled remotely. The direction of the antenna can be controlled remotely, and keeps technicians from being subjected to the hazardous environment required to manually adjust conventional mobile phone cell station antennas.

### BACKGROUND OF THE INVENTION

1. Field of the Invention

The present invention relates to an adjustable antenna mount, and more particularly to an adjustable antenna mount that can adjust the direction of the antenna in a mobile phone cell station.

2. Description of Related Art

Since the number of people using mobile phones is increasing rapidly, the number of mobile phone cell stations that receive and transmit mobile phone signals within a cell are also increasing rapidly. The signal reception of the mobile phone cell station can be effected adversely by the environment including buildings, other antennas, etc. Environmental interference often requires that cell station antennas be adjusted to minimize the effect of the interference.

With reference to FIGS. 6 and 7, a conventional adjustable antenna mounting bracket (42) has a face (not numbered), two clamping arms (not numbered) and multiple clamp compressors (46). An antenna (40) is connected to the face of the adjustable antenna mounting bracket (42). The two clamping arms of the adjustable antenna mounting bracket (42) are mounted on opposite sides of a support (44). The clamp compressors (46) pass through the clamping arms on opposite sides of the support (44) and are tightened to pull the clamping arms together and clamp the support (44) in place. To adjust the direction of the antenna (40), a person must manually loosen the compressors (46) and manually adjust the direction of the antenna (40). Since the antenna (40) is almost always mounted up in high position, such as the top of a building, a person must climb to the high position, which is dangerous. Furthermore, other technicians must remain with the cell receiving equipment to assess the condition of the received signals. The person adjusting the antenna and the person assessing the effect of the adjustment communicate by radio. Adjusting the direction of an antenna with the conventional adjustable antenna mounting bracket is very inconvenient and dangerous.

### SUMMARY OF THE INVENTION

The main objective of the present invention is to provide an adjustable antenna mount for a mobile phone cell station, which can be controlled remotely.

To achieve the objective, an adjustable antenna mount for a mobile phone cell station in accordance with the present invention comprises a stationary base and a rotating base with an antenna. The rotating base is rotatably mounted on the stationary base. To rotate the attached elements, the stationary base comprises a motor and a horizontal gear set, and the rotating base comprises a motor and a vertical gear set. The motors are controlled remotely. With the present invention, the direction of the antenna can be adjusted remotely and keep technicians from having to work in dangerous environments. The present invention conveniently adjusts the direction of the antenna in a mobile phone cell station.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an adjustable antenna mount for a mobile phone cell station in accordance with the present invention;

FIG. 2 is another perspective view of the adjustable antenna mount in FIG.

FIG. 3 is an operational side view in partial section of the adjustable antenna mount in FIG. 1;

FIG. 4 is another operational side view in partial section of the adjustable antenna mount in FIG. 1;

FIG. 5 is an operational top view of the adjustable antenna mount in FIG. 1.

FIG. 6 is a perspective view of a conventional adjustable antenna mounting bracket connected to a support in accordance with the prior art; and

FIG. 7 is a top view of the conventional adjustable antenna mounting bracket in FIG. 6.

### DETAILED DESCRIPTION OF THE INVENTION

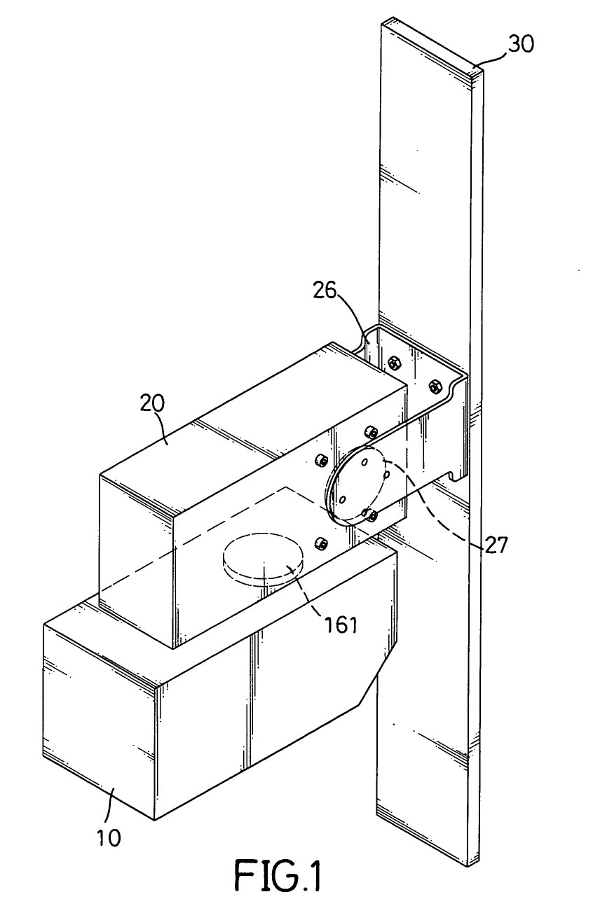

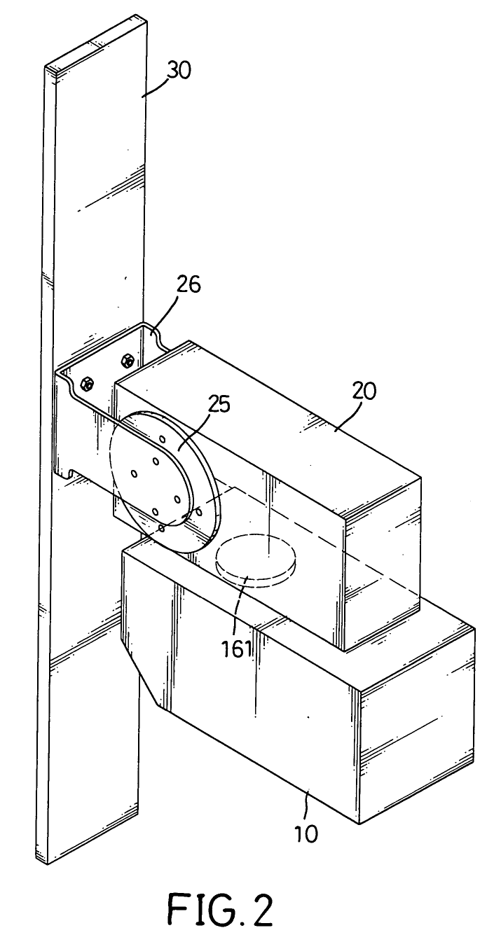

With reference to FIGS. 1 and 2, an adjustable antenna mount for a mobile phone cell station in accordance with the present invention comprises a stationary base (10) and a rotating base (20), and an antenna (30) in the mobile phone cell station is mounted on the adjustable antenna mount.

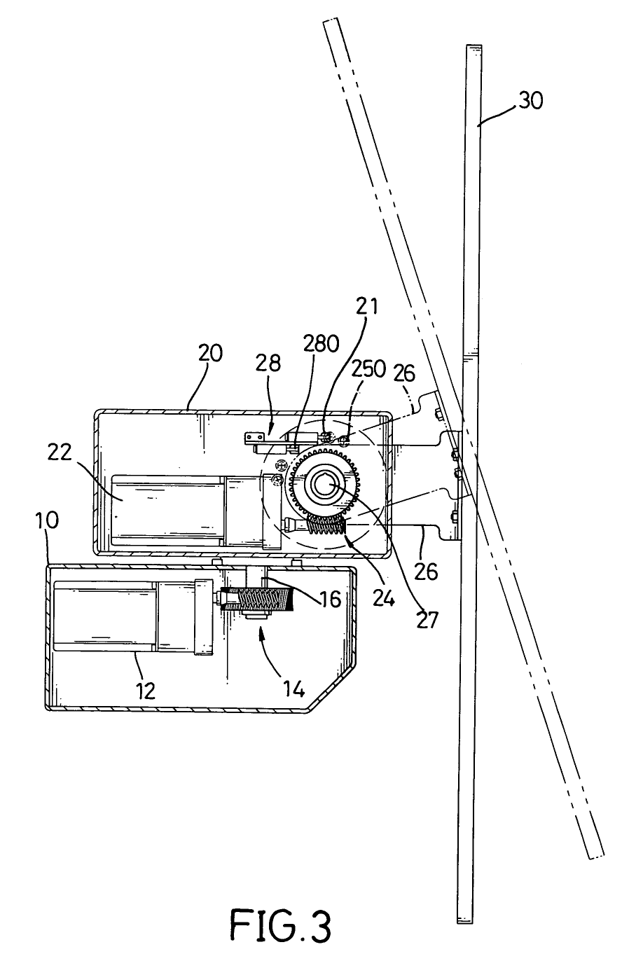

With further reference to FIG. 3, the stationary base (10) comprises a top (not numbered), a motor (12), a horizontal gear set (14), a vertical gear shaft (16) and a controller (not shown).

The motor (12) is mounted securely in the stationary base (10), has a shaft (not numbered) and can drive the shaft in either direction.

The horizontal gear set (14) has a pinion gear (not numbered) and a horizontal gear (not numbered), is connected to and is driven by the motor (12), and decreases the speed of the motor (12). The vertical gear shaft (16) has a vertical axis of rotation (not numbered), a proximal end (not numbered), a distal end (not numbered) and a mounting flange (161) and can rotate in either direction around the vertical axis. The proximal end of the vertical gear shaft (16) is attached to and driven by the horizontal gear. The distal end of the vertical gear shaft (16) passes rotatably through the top of the stationary base (10). The mounting flange (161) is formed integrally on the distal end of the vertical gear shaft (16) on the top of the stationary base (10).

The controller is mounted with the motor (12) to control the motor (12), is conventional and can be operated remotely so further description is omitted.

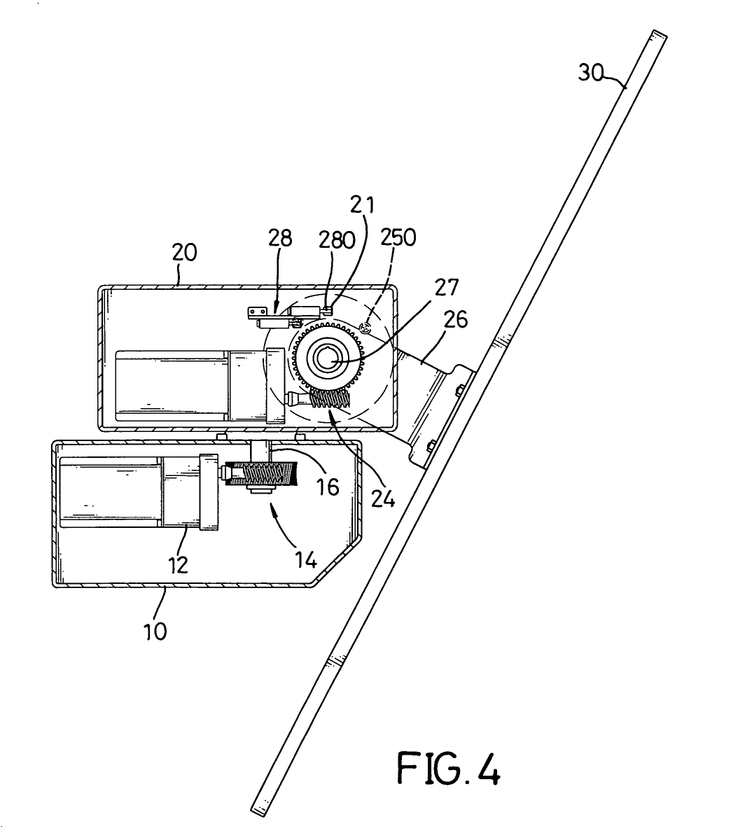

With further reference to FIG. 4, the rotating base (20) comprises a bottom (not numbered), two sides (not numbered), a motor (22), a vertical gear set (24), two rotation plates (25), an antenna bracket (26), a horizontal gear shaft (27), a controller (not shown), multiple optional holes (21) and multiple optional limit switches (28). The bottom of the rotating base (20) is attached to the mounting flange (161) on the top of the stationary base (10). Each of the sides has an inside surface (not numbered) and an outside surface (not numbered).

The motor (22) is mounted securely in the rotating base (20) and has a shaft (not numbered) that has an axis of rotation (not numbered) and can rotate in either direction around the axis.

The controller is mounted with the motor (22) to control the motor (22), is conventional and can be operated remotely so further description is omitted.

The vertical gear set (24) is connected to and is driven by the motor (22), decreases the speed of the motor (22) and changes the axis of rotation of the shaft of the motor (22). The vertical gear set (24) has a pinion gear (not numbered) and a vertical gear (not numbered). The pinion gear is mounted on and driven by the shaft of the motor (22) and meshes with and drives the vertical gear. The horizontal gear shaft (27) has two ends (not numbered) and a middle (not numbered). The middle of the horizontal gear shaft (27) is connected to and driven by the vertical gear in the vertical gear set (24), and the two ends pass respectively through the sides of the rotating base (20). The rotation plates (25) are rotatably mounted respectively on the sides of the rotating base (20) and connected respectively to the ends of the horizontal gear shaft (27). The rotation plates (25) comprise an inner face (not numbered) and an outer face (not numbered), and one of the rotation plates (25) has multiple protrusions (250) mounted on the inner face. Preferably, the multiple protrusions (250) are screws.

The antenna bracket (26) has a face (not numbered) and two arms (not numbered). The face has a front surface (not numbered), a rear surface (not numbered) and two side edges (not numbered). The two arms are formed respectively on the side edges, extend perpendicular from the rear surface and are attached respectively to the outer faces of the rotation plates (25). The antenna (30) is attached to the front surface of the face.

The multiple optional holes (21) are formed through the side that has the rotation plate (25) with multiple protrusions (250) and are radially aligned with the multiple protrusions (250) so some protrusions (250) correspond respectively to the holes (21) when the antenna bracket (26) is at maximum upward vertical travel and other protrusions (250) correspond respectively to the holes (21) when the antenna bracket (26) is at maximum downward vertical travel.

Each limit switch (28) has a switch lever (280) and the optional limit switches (28) are mounted on the inside surface of the side that has the rotation plate (25) with multiple protrusions (250) so the switch levers (280) protrude respectively through and from the holes (21). When the protrusions (250) contact the switch levers (280), the limit switches (28) stop the motor (22) to prevent from the antenna (30) from rotating too much.

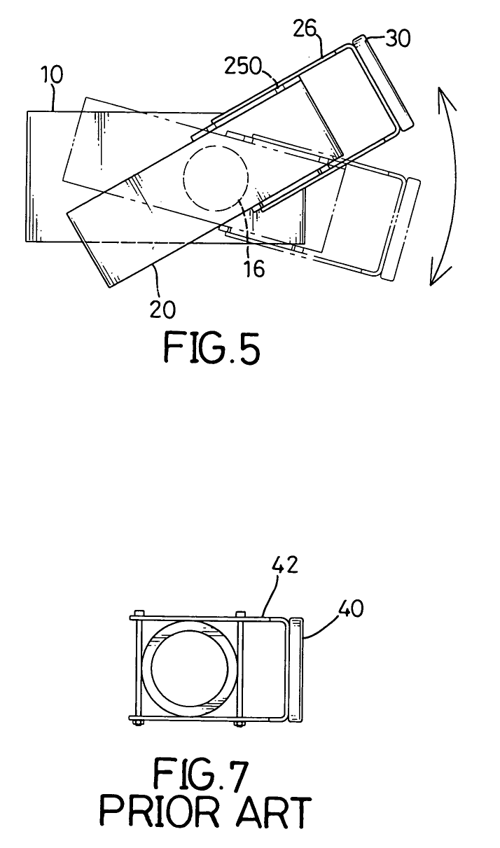

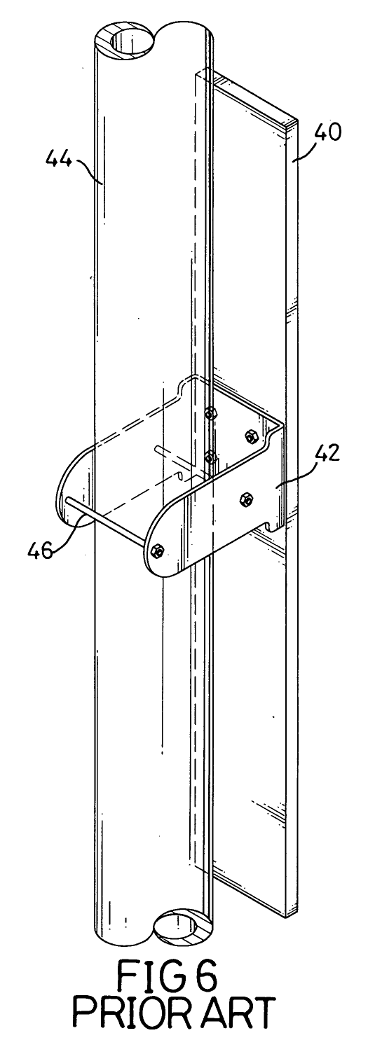

With further reference to FIGS. 3 to 5, the motor (22) in the rotating base (20) rotates the vertical gear set (24), the horizontal shaft (27), the rotation plates (25), the antenna bracket (26) and the antenna (30) in a vertical plane.

The motor (12) in the stationary base (10) rotates the horizontal gear set (14), the vertical gear shaft (16) and the rotating base (20) in a horizontal plane. The motors (12, 22) may be servomotors or a combination of stepping motor and encoder. With such an adjustable antenna mount, a user can adjust the position of the antenna (30) conveniently and safely.

Although the invention has been explained in relation to its preferred embodiment, many other possible modifications and variations can be made without departing from the spirit and scope of the invention as hereinafter claimed.

1. An antenna mount for a mobile phone cell station comprising:
a stationary base comprising
a top;
a motor securely mounted in the stationary base, having a shaft and driving the shaft selectively in either direction;
a horizontal gear set connected to and driven by the motor and having
a pinion gear connected to and driven by the motor; and
a horizontal gear driven by the pinion gear; and
a vertical gear shaft connected to the horizontal gear set and having
a vertical axis of rotation;
a proximal end attached to and driven by the horizontal gear;
a distal end passes rotatably through the top of the stationary base; and
a mounting flange formed integrally on the distal end of the vertical gear shaft on the top of the stationary base and can rotate in either direction around the vertical axis; and
a controller mounted with the motor to control the motor; and
a rotating base rotational mounted on the distal end of the vertical gear shaft in the stationary base and comprising
a bottom attached to the mounting flange on the top of the stationary base;
two sides respectively having inside and outside surfaces;
a motor securely mounted in the rotating base and having a shaft that has an axis of rotation and can rotate in either direction around the axis;
a vertical gear set connected to and driven by the motor and having
a pinion gear mounted on and driven by the motor; and
a vertical gear meshing with and driven by the pinion gear;
a horizontal gear shaft connected to the vertical gear set and having
two ends passing respectively through the sides of the rotating base; and
a middle connected to the vertical gear;
two rotation plates rotatably mounted respectively on the sides of the rotating base and attached respectively to the ends of the horizontal gear shaft and comprising an inner face and an outer face;
an antenna bracket having
a face having a front surface on which an antenna is adapted to be mounted, a rear surface and two side edges; and
two arms formed respectively on the side edges, extending perpendicular from the rear surface and attached respectively to the outer faces of the rotation plates; and
a controller mounted with the motor to control the motor.

2. The antenna mount of a mobile phone cell station as claimed in claim 1 where
one of the rotation plates further comprises multiple protrusions on the inner face of the rotation plate;
multiple holes are formed through the side of the rotating base on which the rotation plate with the multiple protrusions are mounted and are radially aligned with the multiple protrusions; and
the rotating base further comprises multiple limit switches mounted on the side that has the rotation plate with multiple protrusions and respectively comprising a switch lever protruding from the hole.

3. The antenna mount of a mobile phone cell station as claimed in claim 1, wherein the motor is a servomotor.

4. The antenna mount of a mobile phone cell station as claimed in claim 1, wherein the motor is combination stepping motor and encoder.
